(19) United States
(12) Patent Application Publication
(10) Pub. No.: US 2012/0258305 A1
(43) Pub. Date: Oct. 11, 2012

(54) TRANSPARENT FILM AND USE THEREOF

(75) Inventors: Hiromoto Haruta, Ibaraki-shi (JP); Kenjiro Niimi, Ibaraki-shi (JP); Hironobu Machinaga, Ibaraki-shi (JP); Yoshihiro Kitamura, Ibaraki-shi (JP); Ikuya Kuzuhara, Ibaraki-shi (JP)

(73) Assignee: NITTO DENKO CORPORATION, Osaka (JP)

(21) Appl. No.: 13/518,084

(22) PCT Filed: Jan. 20, 2011
(86) PCT No.: PCT/JP2011/051000

§ 371 Date: Jun. 21, 2012

(30) Foreign Application Priority Data
Jan. 21, 2010 (JP) 2010-011396

(51) Int. Cl. B32B 5/00

(52) U.S. Cl. 428/336

(57) ABSTRACT

Provided are a transparent film of an excellent visual quality and a pressure-sensitive adhesive film including the transparent film. Transparent film includes base layer formed of transparent resinous material and top coat layer provided on its first face. Top coat layer has an average thickness Dave of 2 nm to 50 nm and the thickness deviation ΔD is 40% or smaller of the average thickness Dave.

### TECHNICAL FIELD

This invention relates to a transparent film suitable for use as a backing or the like in a surface protection film, which is adhered to an adherend (a subject of protection) to protect the surface thereof. The present application claims priority to Japanese Patent Application No. 2010-011396 filed on Jan. 21, 2010 and the entire contents thereof are incorporated in this description by reference.

### BACKGROUND ART

Surface protection film (surface protection sheet) is generally constructed to comprise an pressure-sensitive adhesive (PSA) provided on a backing (substrate). Adhered on an adherend by the PSA, such surface protection film is used for a purpose for protecting the adherend from scratches and dirt during the processing procedures, transport, and so on. For instance, in manufacturing of a liquid crystal display panel, a polarizing plate to be adhered on a liquid crystal cell is first produced as a roll and then when used, it is unreeled to be cut into desired dimensions corresponding to the liquid crystal cell shape. Here, as a measure taken to prevent the polarizing plate from scratches, which can be caused by friction with conveying rollers during intermediate processing procedures, a surface protection film is adhered to one or each (typically one) face of the polarizing plate. Technical literatures relating to a surface protection film include Patent Documents 1 and 2.

### CITATION LIST

### Patent Literatures

[Patent Document 1] Japanese Patent Application Publication No. 2004-223923.
[Patent Document 2] Japanese Patent Application Publication No. 2008-255332.

### SUMMARY OF INVENTION

### Technical Problem

As such surface protection film, a transparent kind is preferably used because visual inspection can be performed on an adherend (e.g., a polarizing plate) with the film adhered thereon. In recent years, in terms of facilitation, accuracy, etc., of the visual inspection, the desired level of visual quality in surface protection film has been raised. For example, in the back face (the face opposite to the face adhered on an adherend, i.e., the back face of the backing constituting the surface protection film) of surface protection film, abrasion resistance is desired. When an abrasion is present in the surface protection film, one cannot determine whether the abrasion is on the adherend or on the surface protection film while the surface protection film is placed on.

Measures taken to make the back face of protection film abrasion resistant include provision of a hard surface layer to the back face of the protection film. Such a surface layer (top coat layer) is typically formed by applying a coating material to a transparent film surface followed by drying and curing. However, in a case where the protection film placed on an adherend is observed from the back face (for instance, observed in a dark room), when the surface layer is present, the surface protection film tends to have an overall cloudy appearance (i.e., the visual quality is degraded) and the visibility of the adherend surface decreases. When the surface layer is uneven in thickness due to uneven application of the coating material, the reflection rate varies by location (a relatively thick part appears more cloudy) and the visibility (visual quality) is reduced to a greater degree.

An objective of this invention is to provide a transparent film suitable for use as a backing or the like in a surface protection film, which can attain a greater visual quality. Another related objective is to provide a surface protection film having a PSA layer on one face of such a transparent film.

### Solution to Problem

A transparent film provided by this invention comprises a base layer formed of a transparent resinous material and a top coat layer provided on a first face (back face) of the base layer. The top coat layer has an average thickness Dave of 2 nm to 50 nm as well as a thickness deviation ΔD of 40% or smaller, where ΔD is expressed by the following equation:

ΔD=(Dmax−Dmin)/Dave×100 (%)

(in the equation, Dave is the average thickness (nm), Dmax is the maximum thickness (nm), Dmin is the minimum thickness (nm), and ΔD is the thickness deviation (%)).

Another transparent film provided by this invention comprises a base layer formed of a transparent resinous material and a top coat layer provided on a first face (back face) of the base layer. Here, the top coat layer satisfies the following conditions (A) and (B):
(A) having an average thickness Dave of 2 nm to 50 nm.
(B) by X-ray fluorescence analysis, having an X-ray intensity deviation ΔI of 40% or smaller, wherein the X-ray intensity deviation ΔI is expressed by the following equation:

ΔI=(Imax−Imin)/Iave×100 (%)

(in the equation, lave is the average X-ray intensity (kcps) determined by X-ray fluorescence analysis, Imax is the maximum X-ray intensity (kcps), Imin is the minimum X-ray intensity (kcps), and ΔI is the X-ray intensity deviation (%)).

With a transparent film having a composition described above, since the top coat layer is extremely thin while the deviation in thickness is small, reduction in the visual quality (e.g., a phenomenon of overall or partial visible cloudiness) caused by the provision of the top coat layer can be effectively avoided. A transparent film of such excellence in visual quality is suitable as a backing in a surface protection film since accurate visual inspection can be carried out on a subject product (an adherend) through the film. A thin top coat layer is preferred also from a standpoint of reducing alterations to the base layer properties (optical properties, size stability, etc.). As the resinous material forming the base layer, preferably used is one comprising, as its main resinous component, a polyester resin such as a polyethylene phthalate resin, a polyethylene naphthalate resin and the like.

In an embodiment of the art disclosed herein, the top coat layer contains an antistatic ingredient and a binder resin. According to a transparent film having such a composition, by the use of the top coat layer, the transparent film can be provided with antistatic properties. Therefore, as compared to one having a composition where an antistatic layer is given separately from a top coat layer, the transparent film (and thus a surface protection film comprising this transparent film) can be produced more efficiently. In addition, since the transparent film can be constituted with a fewer number of layers, it is advantageous in terms of increasing the visibility of a product surface for visual inspection through the transparent film. In order to obtain antistatic properties more suitable for practical use, the transparent film preferably has a surface resistivity of 100×10⁸Ω or smaller on the top coat layer side. As the antistatic ingredient, a conductive polymer can be preferably used. As the conductive polymer, the top coat layer preferably contains at least a polythiophene. When a top coat layer of such a composition is included, sulfur atom (S) can be used preferably as the subject for the measurement of X-ray intensities in X-ray fluorescence analysis. As the binder resin, for instance, an acrylic resin can be used preferably.

In an embodiment of the art disclosed herein, the top coat layer is crosslinked by a crosslinking agent (e.g., a melamine-based crosslinking agent). This, for instance, may raise at least one of the properties of the top coat layer including scratch resistance, solvent resistance and adhesion to print letters.

In another embodiment of the art disclosed herein, the top coat layer contains a slip agent. Here, slip agent refers to an ingredient effective in decreasing the frictional coefficient when mixed in the material constituting the top coat layer. Such a slip agent-containing top coat layer is preferred because it is likely to produce a transparent film of excellent scratch resistance. For example, when the top coat layer contains a silicone-based slip agent, silicon atom (Si) can be used preferably as the subject for the measurement of X-ray intensities in X-ray fluorescence analysis.

The present invention provides a surface protection film comprising, as its backing, a transparent film disclosed herein. The surface protection film typically comprises the transparent film and a PSA layer provided on a face of the transparent film, with the face being opposite to the top coat layer. Such a surface protection film is suitable especially as a surface protection film for optical parts.

### BRIEF DESCRIPTION OF DRAWINGS

FIG. 1 shows a schematic cross-sectional diagram illustrating a configuration of the surface protection film according to the present invention.

FIG. 2 shows a schematic cross-sectional diagram illustrating another configuration of the surface protection film according to the present invention.

### DESCRIPTION OF EMBODIMENTS

Preferred embodiments of the present invention are described below. Matters necessary to practice this invention other than those specifically referred to in this description may be understood as design matters based on the conventional art in the pertinent field for a person of ordinary skills in the art. The present invention can be practiced based on the contents disclosed in this description and common technical knowledge in the subject field.

The embodiments disclosed in the figures are schematically drawn in order to clearly describe the present invention and are not of accurate representations of dimensions and scales of the surface protection film to be provided as an actual product of this invention.

The transparent film disclosed herein can preferably be used as a backing of a PSA sheet, etc. Such a PSA sheet can be in the form of so-called PSA tape, PSA label, PSA film or the like. In particular, it is suitable as a backing in a surface protection film. Since visual inspection can be accurately carried out through the film, it is especially suitable as a backing in a surface protection film used to protect surfaces of optical parts during processing procedures or transport of the optical parts (e.g., optical parts used as constituents of a liquid crystal display panel such as a polarizing plate, a wave plate, and the like). The surface protection film disclosed herein is typically configured to comprise a PSA layer provided on one face of the transparent film. The PSA layer is typically in a continuous form though it is not limited to such a form. The PSA layer can be in a regular or random pattern of dots, stripes, etc. The surface protection film disclosed herein may come in a roll or a sheet.

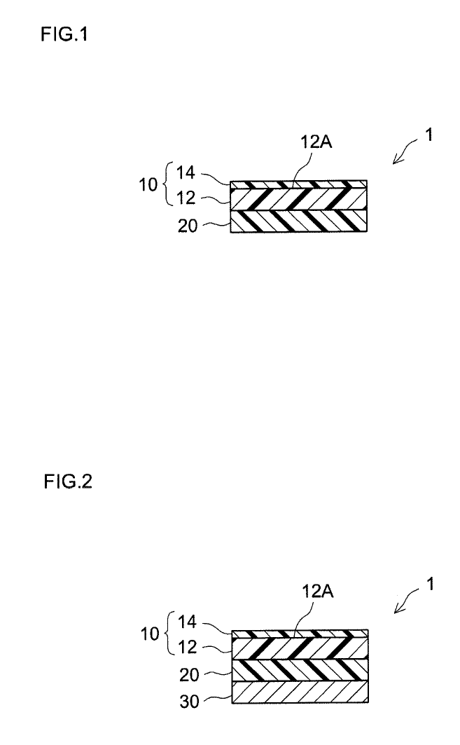

FIG. 1 schematically shows a typical configuration of the transparent film and a surface protection film having, as its backing, a transparent film disclosed herein. Surface protection film 1 comprises transparent film (backing) 10 and PSA layer 20. Transparent film 10 comprises base layer 12 formed of transparent resin film and top coat layer 14 provided directly on top of first face 12A thereof. In transparent film 10, PSA layer 20 is provided on a face opposite to top coat layer 14. Surface protection film 1 is used such that PSA layer 20 is adhered to an adherend (a subject of protection, for example, a surface of an optical part such as a polarizing plate)

Prior to use (i.e., prior to adhering to an adherend), protection film 1 may typically be in the form shown in FIG. 2, where the surface (the face to be adhered to an adherend) of PSA layer 20 is protected by release liner 30 having a release surface on the PSA layer side. Alternatively, it may be in a form such that surface protection film 1 is wound up in a roll whereby the back face (surface of top coat layer 14) of transparent film 10 is in contact with PSA layer 20 to protect the surface thereof.

The base layer of the transparent film disclosed herein may be a resin film obtained by molding a variety of resinous materials into a transparent film. As the resinous material constituting the base layer, preferred is one that can constitute a resin film excellent in one, two or more of the properties including transparency, mechanical strength, thermal stability, water shielding property, isotropy and so on. For example, the preferably used base layer may be a resin film formed of a resinous material containing, as its main resinous component (the primary component of the resinous ingredients; typically a component that accounts for 50% by weight or greater), a polyester-based polymer such as polyethylene terephthalate (PET), polyethylene naphthalate, polybutylene terephthalate and the like; a cellulose-based polymer such as diacetyl cellulose, triacetyl cellulose and the like; a polycarbonate-based polymer; an acrylic polymer such as poly-methyl methacrylate and the like. Other examples of the resinous material include one containing, as its base resin, a styrene-based polymer such as polystyrene, acrylonitrile-styrene co-polymers and the like; an olefinic polymer such as polyethylene, polypropylene, poly-olefins containing a cyclic or a norbomene structure, ethylene-propylene co-polymers and the like; a polyvinyl chloride-based polymer; an amide-based polymer such as nylon 6, nylon 6,6, aromatic polyamides and the like; etc. Other examples of the base resin include imide-based polymers, sulfone-based polymers, polyether sulfone-based polymers, polyetherehterketone-based polymers, polyphenylene sulfide-based polymers, vinyl alcohol-based polymers, vinylidene chloride-based polymers, vinyl butyral-based polymers, arylate-based polymers, polyoxymethylene-based polymers, epoxy-based polymers and so on. The base layer may be of a mixture of two or more kinds of the above-mentioned polymers. The lower the anisotropy in optical properties (phase difference, etc.) is, the more preferable the base layer is. Particularly, in a transparent film used as a backing of a surface protection film for optical parts, it is advantageous that the base layer has a low optical anisotropy. The base layer may be of a single layer or a laminate of multiple layers of different compositions. In typical, it is of a single layer.

The thickness of the base layer may be suitably selected in accordance with the use and purpose of the transparent film. In view of the balance among workability such as strength, handling, etc., cost and facilitation of visual inspection, and so on, it is usually suitable to be about 10 μm to 200 μm, preferable to be about 15 μm to 100 μm and more preferable to be about 20 μm to 70 μm.

The refractive index of the base layer is usually suitable to be about 1.43 to 1.6 and is preferable to be about 1.45 to 1.5. The base layer is preferred to have a light transmission of 70% to 99% and a more preferred base layer has a light transmission of 80% to 97% (e.g., 85% to 95%).

The resinous material constituting the base layer may contain, as necessary, various additives such as an antioxidant, a UV absorbing agent, an antistatic ingredient, a plasticizer, colorants (pigments, dyes, etc.) and so on. The first face (the face on which a top coat layer is provided) of the base layer may have undergone a known or conventional surface treatment such as corona discharge treatment, plasma treatment, UV light irradiation, acid treatment, base treatment, primer coating, etc. These surface treatments may be carried out, for instance, to increase the adhesion (tightness) between the base layer and the top coat layer. Preferably employed is a surface treatment where a polar group such as hydroxyl group (—OH group) is introduced to the base layer surface. In the surface protection film disclosed herein, the transparent film constituting the surface protection film may have undergone the same surface treatment on the second face (the face on which a PSA layer is formed) of the base layer. Such a surface treatment may be carried out to increase the adhesion between the transparent film (backing) and the PSA layer (the anchoring of the PSA layer).

The transparent film disclosed herein comprises a top coat layer on one face (first face) of the base layer, with the top coat layer having an average thickness Dave of 2 nm to 50 nm (typically, 2 nm to 30 nm, preferably 2 nm to 20 nm, for instance, 2 nm to 10 nm). When the Dave of the top coat layer is excessively large, the transparent film is likely to develop overall visible cloudiness; and furthermore, the visual quality of the transparent film (moreover, a surface transparent film comprising this transparent film) tends to degrade. On the other hand, when the Dave of the top coat layer is too small, it may be difficult to form the top coat layer evenly.

The thickness of the top coat layer constituting the transparent film can be determined by observing a cross section of the transparent film by transmission electron microscope (TEM). For instance, a sample of interest may be stained with a heavy metal to make the top coat layer distinguishable, embedded with resin, and sliced ultrathin for TEM analysis of a sample's cross section whereby the obtained data can be utilized as the thickness of the top coat layer in the art disclosed herein. For TEM, a Hitachi TEM model “H-7650” or the like can be used. In the Examples described later, with respect to a cross-sectional image obtained at an accelerating voltage of 100 kV and a magnification of 60,000×, after having processed to a binary form, the thickness (average thickness within the field of view) of the top coat layer was measured by division of the cross-sectional area of the top coat layer by the sample length in the field of view. If the top coat layer is sufficiently distinguishable for observation without any heavy-metal staining, this process may be omitted. Alternatively, the thickness of the top coat layer can be determined by calculation using a calibration curve prepared based on correlations between the thickness determined by TEM and values obtained by various other thickness measuring devices (e.g., a surface profile gauge, an interferometric thickness gauge, an infrared spectrometer, various X-ray diffractometers, and so on).

In a embodiment of the art disclosed herein, the thickness deviation ΔD of the top coat layer is equal to or smaller than 40% (typically, at least 0% up to 40%) of the average thickness Dave of the top coat layer. The thickness deviation ΔD is defined as a value obtained by dividing the difference between the maximum value Dmax and the minimum value Dmin by the average thickness Dave (i.e., ΔD=(Dmax−Dmin)/Dave×100 (%)), with the thickness of the top coat layer having been measured at five different measurement points placed at regular intervals (two neighboring measurement points are desirably at a distance of 2 cm or longer (e.g., about 5 cm or longer) from each other) along a straight line crossing the top coat layer (typically, a straight line crossing the top coat layer in the width direction). The top coat thickness can be directly measured at each measurement point by TEM observation, or, as described above, a value obtained by a suitable thickness gauge can be converted to thickness based on the calibration curve. Here, the average thickness Dave corresponds to the calculated average of the thickness values at the five measurement points. In particular, for instance, Dave and ΔD can be determined in accordance with the thickness measurement method outlined in the Examples described below. With a transparent film having a ΔD of 30% or smaller (more preferably, 25% or smaller, even more preferably 20% or smaller), a better visual quality (e.g., a tendency of having few visible lines or little unevenness) may be obtained. A smaller ΔD is advantageous also in terms of forming a transparent film having a small Dave as well as a low surface resistivity.

In another embodiment of the art disclosed herein, in regard to the top coat layer, the X-ray intensity deviation ΔI obtained by X-ray fluorescence (XRF) analysis is equal to or smaller than 40% of the average value of the X-ray intensities (average X-ray intensity) Iave obtained by the XRF analysis, with a typical ΔI being 0% or greater, but 40% or smaller. The X-ray intensity deviation is defined as a value obtained by dividing the difference between the maximum value Imax and the minimum value Imin by the average X-ray intensity Iave (i.e., ΔI=(Imax−Imin)/lave×100 (%)), with the top coat layer having been analyzed by XRF at five different measurement points placed at regular intervals (two neighboring measurement points are desirably at a distance of 2 cm or longer (e.g., about 5 cm or longer) from each other) along a straight line crossing the top coat layer (typically, a straight line crossing the top coat layer in the width direction). Here, the average X-ray intensity lave corresponds to the calculated average of the X-ray intensities Is at the five measurement points. As the unit of X-ray intensity, kcps (number (kilo counts) per second of X-ray photons entering through a receiving slit) is usually used. In particular, for instance, lave and ΔI can be determined in accordance with the evaluation method of X-ray intensity deviation described later in the Examples. With a transparent film having a ΔI of 30% or smaller (more preferably, 25% or smaller, even more preferably 20% or smaller), a better visual quality (e.g., a tendency of having few visible lines or little unevenness) may be obtained. A smaller ΔI is advantageous also in terms of forming a transparent film having a small Dave as well as a low surface resistivity.

The element for XRF analysis can be any of the XRF-analyzable elements contained in the top coat layer with no particular limitation. Examples of the elements preferably used for XRF analysis include sulfur (which may be the sulfur atom (S) of a conductive polymer (polythiophene, etc.) contained in the top coat layer), silicon atom (which may be the silicon (Si) of a silicone-based slip agent contained in the top coat layer), tin atom (which may be the tin (Sn) of tin oxide particles contained as a filler in the top coat layer), etc. In a preferable embodiment of the art disclosed herein, the X-ray intensity deviation ΔI based on XRF analysis of sulfur is 40% or smaller. In another preferable embodiment, the X-ray intensity deviation ΔI based on XRF analysis of silicon atom is 40% or smaller.

The XRF analysis can be carried out, for instance, as described next. In particular, as the XRF analyzer, a commercial one can be preferably used. A dispersive crystal can be appropriately selected for use. For instance, a Ge crystal, etc., can be preferably used. The output settings, etc., can be suitably selected in accordance with the used instrument. Usually, a sufficient resolution can be obtained with an output of 70 mA at 50 kV. For instance, the XRF settings outlined in the Examples described later can be preferably employed.

From a standpoint of raising the measurement accuracy, under a prescribed XRF condition, an element preferred for analysis has an X-ray intensity per area of a 30 mm diameter circle of about 0.01 kcps or greater (more preferably 0.03 kcps or greater, typically 3.00 kcps or smaller, for example, about 0.05 to 3.00 kcps).

In the transparent film disclosed herein, the surface resistivity in the face on the top coat side is 100×10⁸Ω or smaller (typically, 0.1×10⁸Ω to 100×10⁸Ω). A transparent film exhibiting such a surface resistivity can be preferably utilized as a backing in a surface protection film, which is to be used in processing procedures, transport, etc., of static-sensitive products such as liquid crystal cells, semiconductor devices and so on. The transparent film having a surface resistivity of 50×10⁸Ω or smaller (typically, 0.1×10⁸Ω to 50×10⁸Ω; for instance, 1×10⁸Ω to 50×10⁸Ω) is more preferable. The surface resistivity value can be calculated from a surface resistance value measured using a commercial insulation resistance tester under an atmosphere at 23° C. and 55% RH. In particular, a surface resistivity value obtained by the surface resistivity measuring method outlined in the Examples described later can be preferably used.

The frictional coefficient of the top coat layer is preferably 0.4 or smaller. By use of a top coat layer having such a small frictional coefficient, when a load (a load that may produce scratches) is applied to the top coat layer, the load can be dispersed by the surface of the top coat layer whereby the frictional force by the load can be reduced. Therefore, events of the top coat layer undergoing a cohesive fracture or a peel-off from the base layer (an interfacial fracture) to cause scratches can be prevented more effectively. The lower limit of the frictional coefficient is not particularly limited. From a standpoint of balancing with the other properties (visual quality, printability, etc.), however, the frictional coefficient is usually suitable to be 0.1 or higher (typically, at least 0.1 up to 0.4) and preferable to be 0.15 or higher (typically, at least 0.15 up to 0.4). As the frictional coefficient, for instance, useful values can be obtained by applying a frictional force under a normal load of 40 mN to the back face of the transparent film (i.e., the surface of the top coat layer) in a measurement environment at 23° C. and 50% RH. As measures taken to lower (control) the frictional coefficient in order to obtain the intended frictional coefficient, can be suitably employed means such as addition of various slip agents (leveling agents, etc.) to the top coat layer, increasing the crosslink density by adding a cross-linking agent or adjusting the coating conditions, and so on.

The back face (the top coat surface) of the transparent film disclosed herein preferably has characteristics that readily allow printing with an oil-based ink (e.g., with an oil-based marker). A surface protection film having such a transparent film as the backing is suitably used as a label on an adherend that is subject to protection, whereby the identifying number, etc., can be indicated on the surface protection film while the adherend (e.g., an optical part) having the surface protection film is in procedures such as processing, transporting, etc. Therefore, a transparent film excellent in both printability and visual quality, and a surface protection film comprising this transparent film are preferable. For example, it is preferable to be highly printable with an oil-based ink containing pigments in an alcohol-based solvent. It is preferable that it is unsusceptible to rub-off of printed ink by friction or transferring (i.e., it exhibits good ink adhesion). The level of printability can be assessed, for instance, by the printability test described later. Such a transparent film is also preferred to be solvent resistant with a level where rubbing off the ink with an alcohol (e.g., ethanol) for modification or deletion would not cause significant changes (cloudiness) to the visual appearance. The level of solvent resistance can be assessed, for example, by the solvent resistance test described later.

The top coat layer in the art disclosed herein may comprise, as its basic component (base resin) contributing to coating formation, one, two or more resins selected from various resins such as heat-curable resins, UV light-curable resins, electron beam-curable resins, 2-part resins, and so on. A preferably selected resin exhibits good scratch resistance (e.g., passing the scratch resistance test described later) while being able to form a top coat layer having a good light transmission. In a top coat layer with a composition containing an antistatic ingredient (typically, a conductive polymer) as described later, the base resin can also be considered as a binder (binder resin) for the antistatic ingredient.

Examples of heat-curable resins include those containing, as the base resin, an acrylic resin, an acryl-urethane resin, an acryl-styrene resin, an acryl-silicon resin, a silicone resin, a polysilazane resin, a polyurethane resin, a fluorocarbon resin, a polyester resin, a polyolefin resin or the like. Of these, preferably used heat-curable resins include an acrylic resin, an acryl-urethane resin, an acryl-styrene resin and so forth.

Examples of UV light-curable resins include respective monomers, oligomers, and polymers of various resins such as a polyester resin, an acrylic resin, a urethane resin, an amide resin, a silicone resin, an epoxy resin, and the like; and mixtures of these. For the good UV light curability and tendency to form a very hard layer, a preferably used UV light-curable resin comprises a multi-functional monomer having two or more (more preferably three or more, for instance, about three to six) UV light-polymerizable functional groups per molecule, and/or oligomers thereof. As the multi-functional monomer, acrylic monomers such as a multi-functional acrylate, a multi-functional methacrylate and the like can be used. From a standpoint of adhesion to the base layer, in general, using a heat-curable resin rather than a UV light-curable resin is advantageous.

In an embodiment of the art disclosed herein, the base resin of the top coat layer is a resin (an acrylic resin) comprising, as the base polymer (the primary component of all the polymers; i.e., it accounts for 50% by weight or greater), an acrylic polymer. Here, “acrylic polymer” refers to a polymer whose primary monomeric component (main monomer; i.e., the monomer component that accounts for 50% by weight or greater of all the monomers constituting the acrylic polymer) is a monomer containing at least one (meth)acryloyl group per molecule (hereinafter, this is referred to as an “acrylic monomer”).

In this description, “(meth)acryloyl group” comprehensively refers to acryloyl group and methacryloyl group. Similarly, “(meth)acrylate” comprehensively refers to acrylate and methacrylate.

In an embodiment of the art disclosed herein, the primary component of the acrylic resin is an acrylic polymer containing, as its monomeric component, methyl methacrylate (MAA). Usually, a copolymer of MMA and one, two or more other monomers (in typical, mostly acrylic monomers other than MAA) is preferable. The copolymerization ratio of MMA is typically 50% by weight or greater (e.g., 50 to 90% by weight) and preferably 60% by weight or greater (e.g., 60 to 85% by weight). Preferred examples of monomers that can be used as the co-polymer components include (cyclo)alkyl(meth)acrylates. Here, “(cyclo)alkyl” comprehensively refers to alkyl and cycloalkyl.

As the (cyclo)alkyl(meth)acrylate, for example, an alkyl acrylate with the alkyl group having 1 to 12 carbons such as methyl acrylate, ethyl acrylate, n-butyl acrylate (BA), 2-ethylhexyl acrylate (2EHA), etc.; an alkyl methacrylate with the alkyl group having 1 to 6 carbons such as methyl methacrylate (MMA), ethyl methacrylate, n-butyl methacrylate, isopropyl methacrylate, isobutyl methacrylate, etc.; a cycloalkyl acrylate with the cycloalkyl group having 5 to 7 carbons such as cyclopentyl acrylate, cyclohexyl acrylate, etc.; a cycloalkyl methacrylate with the cycloalkyl group having 5 to 7 carbons such as cyclopentyl methacrylate, cyclohexyl methacrylate (CHMA), etc.; and so on can be used.

The acrylic polymer as the base resin of the top coat layer may comprise, for example, at least MMA and CHMA in its monomeric content. The copolymerization ratio of CHMA can be, for instance, 25% by weight or less (typically, 0.1 to 25% by weight) and it is usually appropriate to be 15% by weight or less (typically, 0.1 to 15% by weight). Alternatively, the acrylic polymer may comprise at least MMA and BA and/or 2EHA in its monomeric content. The copolymerization ratio of BA and 2EHA (when both are contained, their total amount) can be, for instance, 40% by weight or less (typically, 1 to 40% by weight; for example, 10 to 40% by weight) and it is usually appropriate to be 30% by weight or less (typically, 3 to 30% by weight; for instance, 15 to 30% by weight). In a preferred embodiment of the art disclosed herein, the monomeric content (i.e., monomer composition) of the acrylic polymer consists essentially of MMA, CHMA, BA, and/or 2EHA.

The acrylic polymer may contain monomers (the other monomers) other than the above-described monomers copolymerized therein while the effects of the present invention are not significantly impaired. Examples of these monomers include carboxyl group-containing monomers (acrylic acid, methacrylic acid, itaconic acid, maleic acid, fumaric acid, etc.), acid anhydride group-containing monomers (maleic acid anhydride, itaconic acid anhydride, etc.), vinyl esters (vinyl acetate, vinyl propionate, etc.), aromatic vinyl compounds (styrene, α-methylstyrene, etc.), amide group-containing monomers(acrylamide, N,N-dimethylacrylamide, etc.), amino group-containing monomers (aminoethyl(meth)acrylate, N,N-dimethylaminoethyl(meth)acrylate, etc.), imide group-containing monomers (e.g., cyclohexyl maleimide), epoxy group-containing monomers (e.g., glycidyl(meth)acrylate), (meth)acryloyl morpholines, vinyl ethers (e.g., methyl vinyl ether), and so on. The copolymerization ratio of “the other monomers” (when two or more kinds are used, their total amount) is usually preferable to be 5% by weight or less or can be 3% by weight or less; or substantially none of these monomers may be copolymerized therein.

In a preferred embodiment of the art disclosed herein, the acrylic polymer constituting the base resin of the top coat layer is a copolymer with a copolymer composition containing substantially no acidic functional group-containing monomers (acrylic acid, methacrylic acid, etc.) in its copolymer composition. This is especially beneficial in an embodiment where a melamine-based crosslinking agent is used as described later. For instance, a preferred top coat layer contains an acrylic polymer of such a copolymer composition as the base resin while having been crosslinked by a melamine-based crosslinking agent because it can be very hard and producing strong adhesion to the substrate (base layer).

The top coat layer in the art disclosed herein may contain, as necessary, additives such as an antistatic ingredient, a slip agent (a leveling agent, etc.), a crosslinking agent, an antioxidant, colorants (pigments, dyes, etc.), a viscosity-adjusting agent (a thixotropic additive, a thickener, etc.), a coating aid, a catalyst (e.g., a UV light polymerization initiator in a composition containing a UV light-curable resin), etc.

Addition of an antistatic ingredient to the top coat layer is an effective way to obtain a preferred surface resistivity disclosed herein. The antistatic ingredient works as a component to prevent static buildup in a transparent film or a surface protection film comprising this transparent film. When an antistatic ingredient is added to the top coat layer, for instance, conductive organic or inorganic materials, various antistatic agents, etc., can be used as the antistatic ingredient. Of these, conductive organic materials are preferably used.

As the conductive organic materials, various conductive polymers can be preferably used. Examples of these conductive polymers include polythiophenes, polyanilines, polypyrrols, polyethylene imines, allylamine-based polymers, and so on. These conductive polymers can be used singly or in a combination of two or more kinds. They can be used in combination with the other antistatic ingredients (inorganic conductive materials, antistatic agents, etc.). The amount of the conductive polymer can be, relative to 100 parts by weight of the base resin (e.g., an acrylic polymer such as those described above) constituting the top coat layer, for example, 10 to 200 parts by weight and is usually appropriate to be 25 to 150 parts by weight (e.g., 40 to 120 parts by weight). When the amount of the conductive polymer is too small, a preferred surface resistivity value disclosed herein may not be obtained. When the amount of the conductive polymer is excessively large, the thickness deviation ΔD of the top coat layer tends to turn large with a greater likelihood of a reduction in visual quality. Depending on the other components combined to constituting the top coat layer, the conductive polymer may exhibit insufficient solubility, thereby causing a reduction in visual quality or in solvent resistance.

Examples of the conductive polymer preferably used in the art disclosed herein include a polythiophene and a polyaniline. A preferred polythiophene has a weight average molecular weight (hereinafter, referred to as “Mw”) of 40×10⁴ or smaller based on standard polystyrene, with the more preferred Mw being 30×10⁴ or smaller. A preferred polyaniline has a Mw of 50×10⁴ or smaller, with the more preferred Mw being 30×10⁴ or smaller. The Mw values of these conductive polymers are usually preferable to be 0.1×10⁴ or greater and more preferable to be 0.5×10⁴ or greater. In this description, polythiophene refers to a non-substituted or substituted thiophene polymer. Poly(3,4-ethylenedioxythiophene) can be given as a preferred example of substituted thiophene polymers in the art disclosed herein.

When a liquid composition (a coating composition to form a top coat layer) is applied, dried and cured to form a conductive polymer-containing top coat layer, as the conductive polymer for preparation of the composition, a solution or a dispersion of the conductive polymer in water (an aqueous conductive polymer solution) can be preferably used. Such an aqueous conductive polymer solution can be prepared, for instance, by dissolving or dispersing a hydrophilic functional group-containing conductive polymer (which can be synthesized by means such as copolymerization of monomers containing a hydrophilic functional group within the molecule, etc.) in water. Examples of the hydrophilic functional groups include sulfo group, amino group, amide group, imino group, hydroxyl group, mercapto group, hydrazino group, carboxyl group, quaternary ammonium group, organosulfate group (—O—SO₃H), organophosphate group (e.g., —O—PO(OH)₂), and so on. These hydrophilic functional groups may be in the forms of salts. Examples of commercial products of aqueous polythiophene solutions include trade name “Denatron” series available from Nagase ChemteX Corporation. Examples of commercial products of aqueous polyaniline-sulfonic solutions include trade name “aqua-PASS” available from Mitsubishi Rayon Co., Ltd.

In a preferred embodiment of the art disclosed herein, an aqueous polythiophene solution is used to prepare the coating composition. An aqueous polythiophene solution containing a polystyrene sulfonate (PSS) (which may be in a form where a PSS is added as a dopant to a polythiophene) is preferably used. Such an aqueous solution may contain a polythiophene and a PSS at a weight ratio of 1:5 to 1:10. The total amount of the polythiophene and the PSS contained in the aqueous solution can be, for instance, about 1 to 5% by weight. Examples of commercial aqueous polythiophene solutions of this sort include trade name “Baytron” available from H. C. Stark.

When an aqueous polythiophene solution containing a PSS is used, the combined amount of the polythiophene and the PSS can be, relative to 100 parts by weight of the base resin, 10 to 200 parts by weight (usually, 25 to 150 parts by weight; for instance, 40 to 120 parts by weight).

The top coat layer disclosed herein may comprise, as necessary, a conductive polymer and one, two or more other antistatic ingredients (conductive organic materials, conductive inorganic materials, antistatic agents, etc. other than conductive polymers) together. Examples of the conductive inorganic materials include tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, ITO (indium oxide/tin oxide), ATO (antimony oxide/tin oxide), and so on. Examples of the antistatic agents include cationic antistatic agents; anionic antistatic agents; zwitterionic antistatic agents; non-ionic antistatic agents; ionic conductive polymers obtained by copolymerizing monomers containing a cationic, anionic, or zwitterionic conductive group; and so on. In a preferred embodiment, the antistatic ingredient contained in the top coat layer consists essentially of a conductive polymer.

In a preferred embodiment of the top coat layer containing a conductive polymer and a binder resin, the conductive polymer is a polythiophene (which may be a polythiophene doped with a PSS) while the binder resin is an acrylic resin. Such a combination of a conductive polymer and a binder resin is suitable for forming a transparent film having a low surface resistivity even with a thin top coat layer. Use of an acrylic resin containing, as the main component, an acrylic polymer having a copolymer composition in which essentially no acidic functional group-containing monomers are included may produce especially good results.

The art disclosed herein can be preferably practiced in an embodiment where the top coat layer contains a crosslinking agent. As the crosslinking agent, a suitable one can be selected for use from those generally used for resin crosslinking such as melamine-based, isocyanate-based, epoxy-based crosslinking agents. With use of such a crosslinking agent, at least one of the following effects can be achieved: an increased scratch resistance, an increased solvent resistance, an increased ink adhesion, and a reduced frictional coefficient. In a preferred embodiment, at least a melamine-based crosslinking agent is used as the crosslinking agent. Also preferred is an embodiment where the crosslinking agent consists essentially of a melamine-based crosslinking agent. In a composition where an acrylic resin (particularly, an acrylic resin containing, as the primary component, an acrylic polymer with a copolymer composition containing essentially no acidic functional group containing monomer) is used as the base resin, selecting a melamine-based one as the crosslinking agent is especially beneficial.

In order to obtain a better scratch resistance in the transparent film disclosed herein, addition of a slip agent to the cop coat layer is effective. As the slip agent, a conventional fluorocarbon-based or silicone-based slip agent can be preferably used. Use of a silicone-based slip agent is particularly preferred. Examples of the silicone-based slip agent include a polydimethylsiloxane, a polyether-modified polydimethylsiloxane, a polymethylalkylsiloxane, and the like. Also usable is a slip agent containing a fluorocarbon or a silicone compound having an aryl group or an aralkyl group (such a slip agent may produce a highly printable resin film thereby being referred to as printable slip agent). A slip agent containing a fluorocarbon or a silicone compound having a crosslinking-reactive group (a reactive slip agent) can be used as well.

The amount of the slip agent can be, relative to 100 parts by weight of the base resin (e.g., an acrylic polymer described above) constituting the top coat layer, for instance, 5 to 90 parts by weight and is usually suitable to be 10 to 70 parts by weight. In a preferred embodiment, the amount of the slip agent is 15 parts by weight or greater (more preferably, 20 parts by weight or greater; for instance, 25 parts by weight or greater, but typically 50 parts by weight or less) relative to 100 parts by weight of the base resin. When the amount of the slip agent is too little, the scratch resistance tends to be reduced. An excessively large amount of the slip agent may result in insufficient printability or a reduction in the visual quality of the top coat layer.

Such a slip agent is considered to bleed to the surface of the top coat layer and provide lubrication to the surface, thereby lowering the frictional coefficient. Therefore, appropriate use of a slip agent may increase the scratch resistance through a reduced frictional coefficient. The slip agent may contribute to an even surface tension in the top coat layer, a reduced thickness deviation and a fewer interference fringes (moreover, an increased visual quality). This is especially beneficial in a surface protection film used on optical parts. In a case where a UV light-curable resin is used as the resin component of the top coat layer, when a fluorocarbon-based or a silicone-based slip agent is added thereto, the slip agent bleeds to the coating surface (the interface with air) upon application followed by drying of the top coating composition on a substrate. As a result, oxygen-induced inhibition of curing is suppressed when irradiated with UV light so that the UV light-curable resin can be sufficiently cured even in the surface of the top coat layer.

The top coat layer can be preferably formed by a method comprising, applying to the base layer surface a liquid composition in which the resin component and an additive used as necessary are dispersed or dissolved in a suitable solvent. For instance, a preferably employed method includes applying and drying the liquid composition (the top coating composition) on the base layer and, as necessary, subjecting it to a curing treatment (a thermal process, a UV light treatment, etc.). The nonvolatile content (NV) of the composition can be 5% by weight or less (typically, 0.05 to 5% by weight) and is usually appropriate to be 1% by weight or less (e.g., 0.1 to 1% by weight). Too high a NV may be likely to result in an increased composition viscosity, a greater variation in the drying rate across the area, etc., which may in turn make it difficult to form a top coat layer that is evenly thin (that has a small ΔD). In a preferred embodiment, the top coating composition has a NV of 0.5% by weight or less (e.g., 0.3% by weight or less). The lower limit of the NV is not particularly limited though it is usually suitable that it has a NV of 0.05% by weight or greater (e.g., 0.1% by weight or greater). Depending on the base layer material, the surface conditions and so on, too low a NV of the top coating composition may give rise to a repulsive coating with which the ΔD tends to increase.

A preferred solvent to constitute the top coating composition can produce consistent dissolution or dispersion of the top coating components. Such a solvent may be an organic solvent, water, or a mixture of these. As the organic solvent, can be used, for example, one, two or more kinds selected from esters such as ethyl acetate, etc.; ketones such as methyl ethyl ketone, acetone, cyclohexanone, etc.; cyclic ethers such as tetrahydrofuran (THF), dioxane, etc.; aliphatic or alicyclic hydrocarbons such as n-hexane, cyclohexane, etc.; aromatic hydrocarbons such as toluene, xylene, etc.; aliphatic or alicyclic alcohols such as methanol, ethanol, n-propanol, isopropanol, cyclohexanol, etc.; glycol ethers; and so on.

In an embodiment of the art disclosed herein, the solvent constituting the top coating composition comprises a glycol ether as the primary component. As the glycol ether, can be preferably used one, two or more kinds selected from alkylene glycol monoalkyl ethers and dialkylene glycol monoalkyl ethers. Examples include ethylene glycol monomethyl ether, ethylene glycol monoethyl ether, ethylene glycol monopropyl ether, ethylene glycol monobutyl ether, propylene glycol monomethyl ether, propylene glycol monopropyl ether, diethylene glycol monomethyl ether, diethylene glycol monoethyl ether, diethylene glycol monopropyl ether, diethylene glycol monobutyl ether, and diethylene glycol mono-2-ethylhexyl ether.

These glycol ethers are environmentally less harmful as compared to aromatic hydrocarbons such as toluene, etc., and have higher boiling points than lower alcohols and water; and therefore, they suitably allow the applied top coating composition (the coating) to dry evenly overall. In other words, when forming an ultra-thin layer with a small thickness deviation as in the art disclosed herein, with use of a solvent of too high a volatility (drying rate), some regions of the area coated with the composition dry rapidly while solvent puddles are formed in the other slowly drying regions, and with these other regions taking further time to dry, deviations in the thickness of the top coat layer are likely to arise among the rapidly drying regions and the slowly drying regions. When the solvent is excessively volatile, the geometry of the wet coating immediately after the application is likely to remain (in other words, the wet coating dries up before leveling out). This, too, tends to cause formation of a layer having a large thickness deviation ΔD. With use of a highly hydrophilic solvent having a high boiling point such as glycol ethers, the applied wet coating is allowed to suitably effect leveling before drying. Hence, a top coat layer having a small thickness deviation ΔD can be formed. The drying of the coating is preferably carried out at a temperature of 100° C. or above (e.g., 120° C. or above, but typically 160° C. or below). Heating to such a temperature allows better leveling effects. Thus, a top coat layer having a smaller ΔD can be formed.

The PSA layer constituting the surface protection film disclosed herein can be preferably formed using a PSA composition capable of forming a PSA layer having characteristics (peel strength to the adherend surface, non-contaminating properties, etc.) appropriate to a surface protection film. For instance, can be employed a method (direct method) where a PSA composition is directly applied and dried or cured on a base layer to form a PSA layer; another method (transfer method) where a PSA composition is applied and dried or cured on a release liner surface (release face) to form a PSA layer on the surface and this PSA layer is adhered to a base layer thereby transferring the PSA layer to the base layer; and so on. From a standpoint of anchoring the PSA layer, usually, the direct method is preferably employed. For application (typically, application of a coating) of a PSA composition, various methods conventionally known in the field of PSA sheets can be suitably employed such as roll coating, gravure roll coating, reverse roll coating, roll brushing, spray coating, air knife coating, die coating, etc. Though not particularly limited to, the thickness of the PSA layer can be, for instance, about 3 μm to 100 μm and is usually preferable to be about 5 μm to 50 μm. As the method for obtaining the surface protection film disclosed herein, can be employed either one where a PSA layer is provided to a top coated base layer (i.e., a transparent film), or one where a top coat layer is formed after a PSA layer is provided to a base layer. Usually, preferable is the method where a PSA layer is provided to a transparent film.

The surface protection film disclosed herein may be provided in a form where a release liner is adhered to the PSA layer (as a surface protection film having a release liner), as necessary for a purpose of protecting the adhesive surface (of the PSA layer, the face to be adhered to an adherend). For the substrate constituting the release liner, can be used a paper, a synthetic resin film, and so on. Because of the evenly smooth surface, a synthetic resin film can be used preferably. For instance, a resin film of the same resinous material as the base layer can be preferably used as the release liner substrate. The thickness of the release liner may be, for instance, about 5 μm to 200 μm and is usually preferred to be about 10 μm to 100 μm. Of the release liner, the face to be adhered to a PSA layer may have been treated to be releasable or contamination resistant by using a conventional release agent (e.g., a silicone-based, a fluorocarbon-based, long-chain alkyl-based, aliphatic acid amide-based, etc.) or silica gel powder, etc.

Several Examples relating to the present invention are described below, but the present invention is not intended to be limited to these Examples. In the description below, “parts” and “%” are based on the weight unless otherwise specified. The respective characteristics in the description below were measured or evaluated as in the following.

### 1. Measurement of Thickness

With the coating composition of Example 1 described later, by varying the applied amount of the composition, were prepared several samples having top coats of different thickness. Cross sections of these samples were analyzed by transmission electron microscope (TEM) to measure the thickness of the respective top coats.

On the other hand, with respect to each sample's back face, peak intensities of sulfur atom (from the conductive polymer contained in the top coat) were measured, using an X-ray fluorescence analyzer (XRF instrument, model number “ZSX-100e” available from Rigaku Corporation). This XRF analysis was carried out under the following conditions:

[XRF Analysis]

Instrument: XRF instrument, model number “ZSX-100e” available from Rigaku Corporation

X-ray source: vertical Rh tube

Analyzed range: within a circle of 30 mm diameter

Detected X-ray: S-Kα

Dispersive crystal: Ge crystal

Output: 50 kV, 70 mA

Based on the top coat thickness (the measured value) determined by the TEM observation and the data of the XRF analysis, a calibration curve was prepared to derive the top coat thickness from peak intensities observed in the XRF analysis.

Using the calibration curve, the top coat thickness of each Examples transparent film was measured. In particular, along a straight line across the width (in a direction perpendicular to the bar coater's moving direction) of the area having the top coat, starting from one end of the width through the other end, XRF analysis was performed at ⅙, 2/6, 3/6, 4/6, and ⅚ widths. Based on the obtained data (X-ray intensities of sulfur atom (kcps)) together with the top coat composition (the conductive polymer content) and the calibration curve, was determined the thickness of the top coat at each of the five measurement points. The average thickness Dave was calculated by averaging the top coat thickness values of the five measurement points. The thickness deviation ΔD was calculated by substituting the average thickness Dave, the maximum value Dmax and the minimum value Dmin of the top coat thickness values at the five measurement points into the next equation: ΔD=(Dmax−Dmin)/Dave×100 (%).

Furthermore, the X-ray intensity deviation was evaluated by the following procedures:

[Evaluation of X-ray Intensity Deviation]

The average X-ray intensity lave was determined by averaging the sulfur atom X-ray intensities (kcps) obtained at the respective locations by the XRF analysis. The X-ray intensity deviation ΔI was calculated by substituting the average X-ray intensity lave, the maximum value Imax and the minimum value Imin of the X-ray intensities at the respective locations into the next equation: ΔI=(Imax−Imin)/Iave×100 (%).

### 2. Evaluation of Visual Appearance

In a room (a dark room) blocked from outside light, a 100 W fluorescent light (product name “Rupicaline” available from Mitsubishi Electric Corporation) was positioned at 100 cm from the back face (top coat side surface) of each Example's transparent film and the sample's back face was visually observed from different viewpoints (reflection method). In the dark room also, the fluorescent light was placed at 10 cm from the sample's front face (surface opposite to the top coat) and the sample's back face was visually observed from different viewpoints (transmission method). Furthermore, during daylight hours on a sunny day, the sample's back face was visually observed by a window side in a room (a light room) having windows for admission of outside light where any direct sunlight was got. The results of these observations were graded into the following four levels:

E (excellent): no unevenness or lines were observed on the sample's back face under any of the observing conditions.

G (good): a little unevenness or a few lines were observed on the back face in the observation by reflection method in the dark room.

F (fair): a little unevenness or a few lines were observed on the back face in the observation by transmission method in the dark room.

P (poor): unevenness and lines were observed on the back face in the observation in the light room.

### 3. Measurement of Surface Resistivity

Based on JIS K6911, using an insulation resistance tester (product name “Hiresta-up MCP-HT450” available from Mitsubishi Chemical Analytech Co., Ltd.), the surface resistance Rs of the back face of each Example's transparent film was measured under an atmosphere at 23° C. and 55% RH. The applied voltage was 100V and the surface resistance Rs was read at 60 seconds from the start of the measurement. Based on the results, the surface resistivity was calculated according to the next equation:

ρs=Rs×E/V×π(D+d)/(D−d)

Here, in the equation, ps in the equation is the surface resistivity (Ω), Rs is the surface resistance (Ω), E is the applied voltage (V), V is the measured voltage (V), D is the inner diameter (cm) of the tubular surface electrode, and d is the outer diameter (cm) of the inner circle of the surface electrode.

### 4. Evaluation of Anti-clouding

The back face (top coat side surface) of each Example's transparent film sample was strongly rubbed once by an examiner having a glove on, and the transparency of the rubbed region (scratched region) relative to the surroundings was visually inspected. When the clouding is significant, a clear contrast is observed between the transparent rubbed region and the (clouded) surroundings. The observation was carried out in a dark room (reflection method, transmission method) and in a light room in the same manners as the visual appearance evaluation. The obtained observation results were graded into the following four levels:

E (excellent): No visual change (clouding) was observed under any of the observation conditions.

G (good): A little clouding was observed in the observation by reflection method in the dark room.

F (fair): A little clouding was observed in the observation by transmission method in the dark room.

P (poor): Clouding was observed in the observation in the light room.

### 5. Evaluation of Scratch Resistance

A sample of 10 cm² (10 cm by 10 cm) was cut out from each Example's transparent film. In the light room, an examiner scratched the back face of the sample by fingernails and the scratch resistance was evaluated by the presence of scratches caused by the fingernails. In particular, after scratched by fingernails, the sample's back face was observed by optical microscope. When a presence of debris scraped off the top coat was observed, the scratch resistance was rated poor (P) (fail). When no presence of such debris was observed, the scratch resistance was rated good (G) (pass).

### 6. Solvent Resistance

In the dark room, the back face of each Example's transparent film was wiped 15 times with a cleaning cloth (fabric) wet with ethanol and the appearance of the back face was visually observed. As a result, when no visual changes were observed between the regions wiped with ethanol and the other regions (when the appearance changes were observed due to wiping with ethanol), the solvent resistance was rated good (G); and when wiping streaks were realized, the solvent resistance was rated poor (P).

### 7. Evaluation of Printability (Ink Adhesion)

With respect of each Example's transparent film, the top coat surface was printed with a Xstamper available from Shachihata Inc., in a measurement environment at 23° C. and 50% RH. On top of the print, was adhered cellophane PSA tape (product No. 405, 19 mm width) available from Nichiban Co., Ltd. The tape was peeled at a peeling speed of 30 m/min at a peeling angle of 180 degrees. The post-peeling surface was visually observed. When the removed area of the print was 50% or larger, it was rated poor (P); and when the remaining unpeeled area of the print was 50% or larger, it was rated good (G).

### EXAMPLE 1

(Preparation of Coating Composition)

A solution (binder solution A1) containing 5% of an acrylic polymer as a binder (binder polymer B1) in toluene was prepared. The preparation of binder solution A1 was carried out as follows: to a reaction vessel, 25 g of toluene was placed and the temperature inside the reaction vessel was raised to 105° C. To the reaction vessel, was added dropwise continuously over two hours a mixture of 30 g of methyl methacrylate (MMA), 10 g of n-butyl acrylate (BA), 5 g of cyclohexyl methacrylate (CHMA), and 0.2 g of azobisisobutylonitrile. After the addition was completed, the temperature inside the reaction vessel was adjusted to 110 to 115° C., and the copolymerization reaction was carried out by keeping it at this temperature range for 3 hours. When the 3 hours had elapsed, to the reaction vessel, was added dropwise a mixture of 4 g of toluene and 0.1 g of azobisisobutylonitrile and the resultant was kept at the same temperature range for one hour. Then, the temperature inside the reaction vessel was cooled to 90° C. and the mixture was diluted with additional toluene to 5% NV.

To a 150-mL beaker, were added 2 g of binder solution A1 (containing 0.1 g of binder polymer B1) and 40 g of ethylene glycol monoethyl ether, and the mixture was stirred. To this beaker, were added 1.2 g of aqueous conductive polymer solution C1 (4.0% NV) containing polyethylene dioxythiophene (PEDT) and polystyrene sulfonate (PSS), 55 g of ethylene glycol monomethyl ether, 0.05 g of a polyether-modified polydimethylsiloxane-based leveling agent (product name “BYK-300” available from BYK Chemie, 52% NV), and a melamine-based crosslinking agent; and the mixture was vigorously stirred for about 20 minutes. By this, was prepared a coating composition containing, relative to 100 parts of binder polymer B1 (base resin), 50 parts of conductive polymer and 30 parts of slip agent (both based on the nonvolatile contents) and further containing a melamine-based crosslinking agent.

(Formation of Top Coat Layer)

To a 38 μm thick by 30 cm wide by 40 cm long transparent polyethylene phthalate (PET) film having a first surface treated with corona discharge, the coating composition was applied on the corona discharged surface using bar coater #3 to a pre-dry thickness of about 3.5 μm. The resulting coating was allowed to dry at 130° C. for 2 minutes to form a top coat layer. By this, was prepared a transparent film sample having a transparent top coat layer on one face of a PET film.

(Fabrication of Surface Protection Film)

A first face of a PET film was treated with a silicone-based release agent to prepare a release sheet. On top of the release face (release agent-treated face) of the release sheet, a 25 μm thick acrylic PSA layer was formed. The PSA layer was adhered to the second surface (surface without a top coat layer) of the PET film to prepare a surface protection film. It is noted that in this Example and in any of the following Examples, the respective measurements and evaluations shown in Table 2 were performed on the films (transparent film samples) prior to adhering the PSA layer.

### EXAMPLE 2

Relative to Example 1, the amount of aqueous conductive polymer solution C1 was changed from 1.2 g to 2.5 g and the amount of ethylene glycol monomethyl ether was changed from 55 g to 17 g. The rest was carried out in the same manner as Example 1 to prepare a transparent film sample of this Example. Using this transparent film sample, a surface protection film was prepared in the same manner as Example 1.

### EXAMPLE 3

Relative to Example 1, the amount of ethylene glycol monomethyl ether was changed from 55 g to 5 g. The rest was carried out in the same manner as Example 1 to prepare a transparent film sample of this Example. Using this transparent film sample, a surface protection film was prepared in the same manner as Example 1.

### EXAMPLE 4

Relative to Example 1, the amount of ethylene glycol monoethyl ether was changed from 40 g to 15 g and the amount of aqueous conductive polymer solution C1 was changed from 1.2 g to 0.7 g while no ethylene glycol monomethyl ether was used. The rest was carried out in the same manner as Example 1 to prepare a transparent film sample of this Example. Using this transparent film sample, a surface protection film was prepared in the same manner as Example 1.

### EXAMPLE 5

Except that the melamine-based crosslinking agent was not used, a transparent film sample of this Example was prepared in the same manner as Example 4. Using this transparent film sample, a surface protection film was prepared in the same manner as Example 1.

### EXAMPLE 6

Except that the slip agent (BYK-300) was not used, a transparent film sample of this Example was prepared in the same manner as Example 4. Using this transparent film sample, a surface protection film was prepared in the same manner as Example 1.

### EXAMPLE 7

Except that the amount of ethylene glycol monoethyl ether was changed from 15 g to 10 g, a transparent film sample of this Example was prepared in the same manner as Example 4. Using this transparent film sample, a surface protection film was prepared in the same manner as Example 1.

### EXAMPLE 8

Except that the amount of ethylene glycol monoethyl ether was changed from 15 g to 5 g, a transparent film sample of this Example was prepared in the same manner as Example 4. Using this transparent film sample, a surface protection film was prepared in the same manner as Example 1.

### EXAMPLE 9

(Preparation of Coating Composition)

To a reaction vessel, 25 g of toluene was placed and the temperature inside the reaction vessel was raised to 105° C. To the reaction vessel, was added dropwise continuously over two hours a mixture of 32 g of methyl methacrylate (MMA), 5 g of n-butyl acrylate (BA), 0.7 g of methacrylic acid (MAA), 5 g of cyclohexyl methacrylate (CHMA), and 0.2 g of azobisisobutylonitrile. After the addition was completed, the temperature inside the reaction vessel was adjusted to 110 to 115° C., and the copolymerization reaction was carried out by keeping it at this temperature range for 3 hours. When the 3 hours had elapsed, to the reaction vessel, was added dropwise a mixture of 4 g of toluene and 0.1 g of azobisisobutylonitrile and the resultant was kept at the same temperature range for one hour. Then, the temperature inside the reaction vessel was cooled to 90° C. and the mixture was diluted with 31 g of toluene. By this, was prepared a solution (binder solution A2) containing about 42% of an acrylic polymer (binder polymer B2, Tg 73.4° C.) as a binder in toluene.

To a 150-mL beaker, were added binder solution A2 (containing 2.3 g of binder polymer B2) and 29.3 g of ethylene glycol monoethyl ether, and the mixture was stirred. To this beaker, were added 14 g of aqueous conductive polymer solution C2 (1.3% NV) containing PEDT and PSS, 19.5 g of ethylene glycol monomethyl ether, 32 g of propylene glycol monomethyl ether, 1.7 g of N-methylpyrrolidone, and 0.5 g of a slip agent (BYK-300 was used); and the mixture was vigorously stirred for about 30 minutes. By this, was prepared a coating composition containing, relative to 100 parts of binder polymer B2 (base resin), 8 parts of conductive polymer and 12 parts of slip agent (both based on the nonvolatile contents). No crosslinking agent was added in this composition.

(Formation of Top Coat)

To a 38 μm thick by 30 cm wide by 40 cm long transparent polyethylene phthalate (PET) film having a first surface treated with corona discharge, the coating composition was applied on the corona discharged surface using bar coater #7 to a pre-dry thickness of about 16 μm. The resulting coating was allowed to dry at 80° C. for 2 minutes to form a top coat layer. By this, was prepared a transparent film sample having a transparent top coat layer on one face of a PET film.

Using this transparent film sample, a surface protection film was prepared in the same manner as Example 1.

Regarding these transparent film samples, Table 1 shows the composition profiles of the coating compositions used to form the top coat layers and Table 2 shows the results of the above-described various measurements and evaluations. Table 2 includes the profiles of the top coat layers as well.

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Binder solution A1 (g) | 2 | 2 | 2 | 2 | 2 | 2 | 2 | 2 | — |
| Binder solution A2 (g) | — | — | — | — | — | — | — | — | 3 |
| Ethylene glycol | 40 | 40 | 40 | 15 | 15 | 15 | 10 | 5 | 29.3 |
| monoethyl ether (g) | | | | | | | | | |
| Conductive polymer | 1.2 | 2.5 | 1.2 | 0.7 | 0.7 | 0.7 | 0.7 | 0.7 | — |
| solution C1 (g) | | | | | | | | | |
| Conductive polymer | — | — | — | — | — | — | — | — | 14 |
| solution C2 (g) | | | | | | | | | |
| Ethylene glycol | 55 | 17 | 5 | — | — | — | — | — | 19.5 |
| monomehtyl ether (g) | | | | | | | | | |
| Propylene glycol | — | — | — | — | — | — | — | — | 32 |
| monomethyl ether (g) | | | | | | | | | |
| NMP (g) | — | — | — | — | — | — | — | — | 1.7 |
| Slip agent (g) | 0.05 | 0.05 | 0.05 | 0.05 | 0.05 | none | 0.05 | 0.05 | 0.5 |
| Crosslinking agent | present | present | present | present | absent | present | present | present | absent |
| NV of coating | 0.2 | 0.4 | 0.4 | 0.8 | 0.8 | 0.8 | 1.0 | 1.5 | 5.2 |
| composition (%) | | | | | | | | | |

TABLE 2

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Binder polymer B1 (part) | 100 | 100 | 100 | 100 | 100 | 100 | 100 | 100 | — |
| (copolymer composition | | | | | | | | | |
| MMA/BA/CHMA = | | | | | | | | | |
| 30/10/5) | | | | | | | | | |
| Binder polymer B2 (part) | — | — | — | — | — | — | — | — | 100 |
| (copolymer composition | | | | | | | | | |
| MMA/BA/MAA/CHMA = | | | | | | | | | |
| 32/5/0.7/5) | | | | | | | | | |
| Conductive polymer (part) | 50 | 100 | 50 | 30 | 30 | 30 | 30 | 30 | 8 |
| Slip agent component (part) | 30 | 30 | 30 | 30 | 30 | none | 30 | 30 | 12 |
| Crosslinking agent | present | present | present | present | absent | present | present | present | absent |
| Average thickness of top coat | 7.8 | 18.9 | 16.7 | 34.6 | 33.8 | 42.2 | 51.2 | 64.9 | 645.3 |
| layer Dave (nm) | | | | | | | | | |
| Thickness deviation of top | 15.8 | 34.4 | 21.6 | 12.5 | 13.3 | 22.8 | 34.4 | 41.8 | 54.9 |
| coat layer ΔD (%) | | | | | | | | | |
| Average X-ray intensity Iave | 0.43 | 2.07 | 0.91 | 1.13 | 1.11 | 1.38 | 1.68 | 2.13 | 5.64 |
| of top coat layer (kcps) | | | | | | | | | |
| X-ray intensity deviation ΔI | 15.8 | 34.4 | 21.6 | 12.5 | 13.3 | 22.8 | 34.4 | 41.8 | 54.9 |
| of top coat layer (%) | | | | | | | | | |
| Visual appearance | E | F | G | G | G | G | P | P | P |
| Surface resistivity (× 10⁸ Ω) | 43 | 3.3 | 23 | 45 | 19 | 29 | 8.9 | 0.97 | 0.21 |
| Anti-clouding | G | G | G | F | F | E | P | P | P |
| Scratch resistance | G | G | G | G | P | P | G | G | P |
| Solvent resistance | G | P | G | G | P | G | G | G | P |
| Ink adhesion | G | G | G | G | P | G | G | G | P |

As shown in these tables, the transparent film samples of Example 1 to 6, each having a top coat Dave of 2 nm to 50 nm and ΔD of 40% or smaller, all exhibited good results in the evaluation of the visual appearance. Example 1 and Examples 3 to 6, each having a ΔD of 30% or smaller, showed better visual qualities as compared to Example 2 having a ΔD above 30%. With Example 1 having a Dave of 2 nm to 10 nm and a ΔD of 20% or smaller, particularly good results were obtained. Moreover, the transparent films of Examples 1 to 6, despite of their thinness, all exhibited a low surface resistivity of 50×10⁸Ω or smaller. In regard to the anti-clouding characteristics, Examples 1 to 6 all showed practical levels. Of Example 1 to Example 5 in which a slip agent was used, Examples 1 to 3, each having a Dave of 30 nm or smaller, exhibited better anti-clouding characteristics. Example 1 to Example 4, in which the top coat layer contained a slip agent and a melamine-based crosslinking agent, all showed good scratch resistance. Example 6 containing no slip agent, despite of the Dave of 40 nm or greater, showed good anti-clouding characteristics. It is noted, however, in attaining high levels of both anti-clouding and scratch resistance, a top coat layer containing a slip agent is advantageous. Addition of a melamine-based crosslinking agent to the top coat was found effective in increasing the solvent resistance and the ink adhesion.

On the other hand, the transparent film samples of Example 7 to Example 9, each having a Dave above 50 nm, were all inferior to Examples 1 to 6 in visual quality. As observed in the comparison of Example 2 and Example 7 having similar ΔD values, in order to obtain a good visual quality, it is important that the conditions of Dave≦50 nm as well as ΔD≦40% are satisfied. Furthermore, the transparent film samples of Example 7 to Example 9 were inferior to Examples 1 to 6 in anti-clouding characteristics. This is considered that when the Dave exceeds 50 nm, an excessive amount of slip agent was present in the top coat surface and the slip agent partially may have oiled out; and in the anti-clouding evaluation test described above, the oil out of the slip agent was wiped off, whereby the anti-clouding properties were degraded.

### INDUSTRIAL APPLICABILITY

The transparent film disclosed herein may be preferably used as backings (support substrate) in various kinds of surface protection film. The surface protection film disclosed herein is suitably used for protecting optical parts used as components of a liquid crystal display panel, a plasma display panel (PDP), an organic electroluminescence (EL) display, etc., during their manufacturing, transport, etc. Especially, it is useful as a surface protection film applied on optical parts such as a polarizing plate (polarizing film), a wave plate, a retardation plate, an optical compensation film, a brightening film, a light-diffusing sheet, a reflective sheet, and so on, which are used in a liquid crystal display panel.

1. A transparent film comprising a base layer formed of a transparent resinous material and a top coat layer provided on a first face of the base layer,
wherein the top coat layer has an average thickness Dave of 2 nm to 50 nm and a thickness deviation ΔD of 40% or smaller, with ΔD being expressed by the following equation:
ΔD=(Dmax−Dmin)/Dave×100 (%)
in which equation, Dave is the average thickness (nm), Dmax is the maximum thickness (nm), Dmin is the minimum thickness (nm) and ΔD is the thickness deviation (%).

2. The transparent film according to claim 1, wherein the top coat layer comprises an antistatic ingredient and a binder resin, and has a surface resistivity of 100×10⁸Ω or smaller.

3. The transparent film according to claim 2, wherein the top coat layer comprises at least a conductive polymer as the antistatic ingredient.

4. The transparent film according to claim 3, wherein the top coat layer comprises at least polythiophene as the conductive polymer.

5. The transparent film according to claim 2, wherein the top coat layer comprises an acrylic resin as the binder resin.

6. The transparent film according to claim 1, wherein the top coat layer is crosslinked by a melamine-based crosslinking agent.

7. The transparent film according to claim 1, wherein the top coat layer comprises a slip agent.

8. A transparent film comprising a base layer formed of a transparent resinous material and a top coat layer provided on a first face of the base layer,
with the top coat layer satisfying each of the following conditions:
(A) having an average thickness Dave of 2 nm to 50 nm; and
(B) by X-ray fluorescence analysis, having an X-ray intensity deviation ΔI of 40% or smaller, wherein the X-ray intensity deviation ΔI is expressed by the following equation:
ΔI=(Imax−Imin)/Iave×100 (%)
in which equation, lave is the average X-ray intensity (kcps) determined by X-ray fluorescence analysis, Imax is the maximum X-ray intensity (kcps), Imin is the minimum X-ray intensity (kcps), and ΔI is the X-ray intensity deviation (%).

9. The transparent film according to claim 8, wherein the top coat layer comprises an antistatic ingredient and a binder resin, and has a surface resistivity of 100×10⁸Ω or smaller.

10. The transparent film according to claim 9, comprising at least polythiophene as the antistatic ingredient, with the X-ray intensity being measured with respect to sulfur atom.

11. The transparent film according to claim 8, wherein the top coat layer comprises a silicone-based slip agent and the X-ray intensity is measured with respect to silicon atom.

12. The transparent film according to claim 1, wherein the resinous material constituting the base layer comprises, as its primary resin component, a polyethylene phthalate resin or a polyethylene naphthalate resin.

13. A pressure-sensitive adhesive film, comprising,
the transparent film according to claim 1, and
a pressure-sensitive adhesive layer provided on a surface of the transparent film, with the surface being opposite to the top coat layer.

14. A surface protection film, comprising,
the transparent film according to claim 1, and
a pressure-sensitive adhesive layer provided on a surface of the transparent film, with the surface being opposite to the top coat layer.

15. A surface protection film for optics, comprising,
the transparent film according to claim 1, and
a pressure-sensitive adhesive layer provided on a surface of the transparent film, with the surface being opposite to the top coat layer.
